(19) United States
(12) Patent Application Publication
(10) Pub. No.: US 2009/0033654 A1
(43) Pub. Date: Feb. 5, 2009

(54) SYSTEM AND METHOD FOR VISUALLY REPRESENTING AN OBJECT TO A USER

(75) Inventor: Munish Sikka, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: THINK/THING, Chicago, IL (US)

(21) Appl. No.: 11/831,610

(22) Filed: Jul. 31, 2007

(51) Int. Cl. G06T 15/00; G06F 3/033

(52) U.S. Cl. 345/419; 715/863

(57) ABSTRACT

A first two-dimensional geometric representation of a first moving object from a received first image is determined. A first visual indication to render the first two-dimensional geometric representation of the first moving object in a three-dimensional space is obtained. The first moving object is visually rendered in the three-dimensional space to a user according to the first two-dimensional geometric representation.

### RELATED APPLICATION

“System and Method for Tracking Movement of Joints” by Munish Sikka having Attorney's Docket No. 90590 filed on the same day as the present application, the contents of which are incorporated herein by reference in their entirety.

### FIELD OF THE INVENTION

The field of the invention relates to image creation in two-dimensional and/or three-dimensional space and, more specifically, to creating images for display to a user.

### BACKGROUND OF THE INVENTION

Two general approaches have been used to represent drawings electronically. In one approach, all of the points on the surfaces of the object are given a mathematical, three-dimensional representation that can be related to the translational, rotational, or scalar transformation of the points. Different views may also be derived from this representation by specifying the position of a camera in three-dimensional space around the three-dimensional mathematical representation of the object.

In another previous approach, a two-dimensional projection of a three-dimensional object was created. However, this representation had only a single three-dimensional view and no other views can be derived from this view because it was a flat drawing, much like a three-dimensional perspective drawing contained on a sheet of paper.

Regardless of how the drawing is represented, various techniques have been introduced to allow a user to initially render objects on the computer. Almost all of these approaches have utilized extra hardware that has been connected to the computer either by using wires, cables, or wireless connections.

In one previous approach, various keyboard/mouse combinations were used to draw objects. Straight lines were created by clicking and moving the computer mouse. Lines could be combined or connected to form different objects. In another example, computer tablets were used wherein an electronic drawing surface contained a sensor array that sensed the movement of an electromagnetic pen. By moving the pen across the sensor array of the tablet, objects were drawn. In still other approaches, hardware was attached to a computer and the hardware contained mechanical arms connected by moveable joints. The user moved the hardware to mimic the creation of a drawing on the screen.

Unfortunately, all of the above-mentioned techniques suffered from various problems. The use of a computer mouse typically required the attachment of wires. When wireless connections were used, electromagnetic interference often caused problems. Electromagnetic approaches with computer tablets were expensive and subject to interference. Mechanical approaches were typically costly and unwieldy to use. All of the above mentioned approaches typically required the use of additional equipment (hardware and/or software). Additionally, the previous approaches did not provide a co-relation to how scaled model representations of objects were built in real-life.

### SUMMARY OF THE INVENTION

Approaches are described that allow the creation and rendering of objects in three-dimensional space to users. Images of moving objects are obtained and geometric patterns associated with the objects are determined. The geometric patterns of various objects in various positions can be used to create images of other more complex objects (e.g., models). These approaches do not require the use of additional computer attachments (e.g., a keyboard, a computer mouse, or the like) or wires. In addition, these approaches are intuitive and easy to use, and result in increased user satisfaction with the system.

In many of these embodiments, a first two-dimensional geometric representation of a first moving object is determined from at least one received first image. A first visual indication to render the first two-dimensional geometric representation of the first moving object in a three-dimensional space is obtained. The first moving object is visually rendered in the three-dimensional space to a user according to the first two-dimensional geometric representation.

The two-dimensional geometric representation may take many forms. For example, the two-dimensional geometric representation may be a line or a polygon. The image capture device may be any type of image capture device utilizing any type of technology. Additionally, the image capture device may be a single image capture device or a plurality of image capture devices.

A second two-dimensional geometric representation of a second moving object from at least one received second image may then be determined. A second indication to render the second two-dimensional geometric representation of the second moving object in the three-dimensional space may be obtained. The second moving object may be responsively visually rendered in the three-dimensional space to the user according to the second two-dimensional geometric representation. Consequently, both the first and second two-dimensional representations are rendered and presented to the user.

The first and second visual indications may also take on a number of forms. For example, the indications may be hand gestures, the introduction of a command object, or the expiration of a time period during which the original first object remain stationary. Other examples of indications are possible.

The received images may be obtained in different ways and from different sources. For example, a set of images may be captured or the system may use a set of stored images.

In some of these approaches, the position of the first moving object may be located in the three-dimensional space. In this case, a set of edge vectors may be determined and the set of edge vectors may be evaluated to determine the shape of the first two-dimensional geometric representation.

Thus, approaches are provided that allow the rendering of objects in three-dimensional space to users. These approaches do not require the use of computer attachments (e.g., a keyboard, a computer mouse, or the like) or wires, are intuitive and easy to use, are cost effective to implement, and result in increased user satisfaction with the system.

### BRIEF DESCRIPTION OF THE DRAWINGS

FIG. 1 is a block diagram of a system for rendering images to a user according to various embodiments of the present invention;

FIG. 2 is a flowchart of an approach for visually rendering images to users according to various embodiments of the present invention;

FIG. 3 illustrates various aspects of rendering images to users according to various embodiments of the present invention;

FIG. 4 illustrates various aspects of determining motion and rendering the images to users according to various embodiments of the present invention;

FIG. 5 is a flowchart of an approach for determining a visual geometric representation of an object according to various embodiments of the present invention;

FIG. 6 is a flowchart of an approach for determining moving objects in an image according to various embodiments of the present invention;

FIG. 7 is a diagram illustrating the determination of moving objects according to various embodiments of the present invention;

FIG. 8 is a flowchart of an approach for determining the shape of an object according to various embodiments of the present invention;

FIG. 9 is a flowchart of an approach for determining a best estimate for the size of an object according to various embodiments of the present invention; and

FIG. 10 is a flowchart showing one example of rendering an object to a user according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### Descriptioin of the Preferred Embodiments

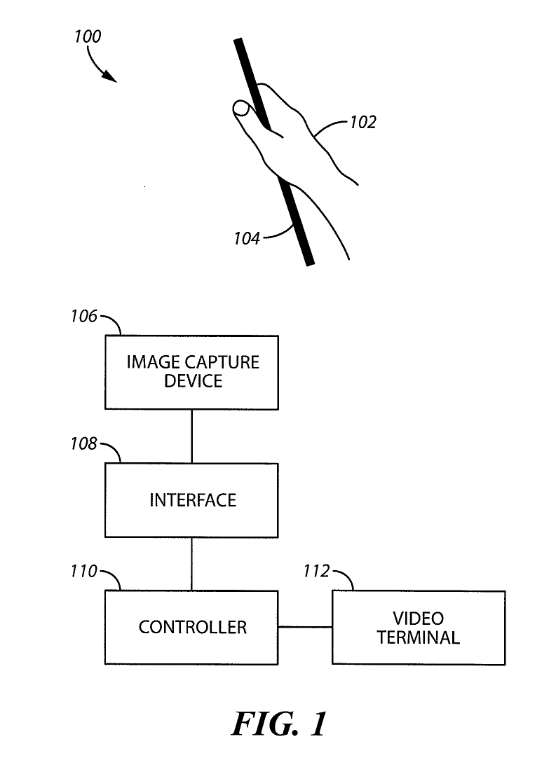

Referring now to FIG. 1, a system 100 for visually representing an object to a user is described. The system 100 includes an image capture device 106, which obtains an image of a hand 102 that is moving an object 104. An interface 108 receives images from the image capture device 106 either over a wire or via a wireless connection. The interface 108 is coupled to a controller 110. The controller 110 processes the images and transmits the processed images to a display 112 (e.g., Liquid Crystal Display (LCD) or Cathode Ray Tube (CRT) display) either directly or via the interface 108. The controller 110 removes the hand 102 from the image before displaying the processed images to the user. This may be done by using previously stored templates of hand images that the controller 110 can use to remove the hand 102 from the processed image. As is described herein, the controller 110 processes captured images of objects thereby allowing a user to create an image of a more complex object in three-dimensional space at the display 112. Once created, the complex object may be stored in memory (either at the controller 110 or the display 112) for future use or further processing.

The image capture device 106 may be any suitable device that is used to acquire images. In this respect, the image capture device 106 may be a video camera, a digital camera, or a camera on a satellite. Other types of cameras or image capture devices (e.g., using other technologies such as ultrasound, infrared) may also be used.

Moreover, the images of the object 104 can be obtained from a variety of different image capture devices in various configurations. For example, the images may be obtained from a single image capture device. In other examples, multiple image capture devices can be used to obtain the images.

The interface 108 is any type of device or combination of devices that utilizes any combination of hardware and programmed software to convert signals between the different formats utilized by the image capture device 106, controller 110, and display 112. In one example, the interface 108 converts the raw video data into a format usable by the controller 110.

The controller 110 is any type of programmed control device (e.g., a microprocessor) capable of executing computer instructions. The controller 110 may be directly coupled to the display 112 or be connected via the interface 108. Additionally, the controller 110 may include any type of memory or combination of memory devices.

The display 112 is any type of device allowing the rendering of objects visually to a user. In this regard, the display may utilize any type of display technology. The display may be connected to other systems via any type of connection. In one example, the display 112 is connected to the Internet. Consequently, images rendered at the display 112 may be sent to other systems for further processing and/or display.

In one example of the operation of the system of FIG. 1, a first two-dimensional geometric representation of the moving object 104 (e.g., a pen) indicated by at least one first image is determined. A first visual indication (e.g., a hand gesture, expiration of a timer, or introduction of a command object) to render the first two-dimensional geometric representation of the first moving object (e.g., a line) in a three-dimensional space is obtained. The first moving object 104 is responsively visually rendered in the three-dimensional space to a user on the display 112 according to the first two-dimensional geometric representation.

The two-dimensional geometric representation associated with the object may take many forms. For example, the two-dimensional geometric representation may be a line or a polygon. Other examples of representations are possible.

A second two-dimensional geometric representation of a second moving object from at least one second image received from the image capture device 106 may be determined. For example, a plane (e.g., a sheet of paper) may be introduced into the view of the image capture device 106. A second indication (e.g., a hand gesture, expiration of a timer, or introduction of a command object) to render the second two-dimensional geometric representation of the second moving object in the three-dimensional space may be obtained. The second moving object may be responsively visually rendered in the three-dimensional space to the user on the display 112 according to the second two-dimensional geometric representation. Further geometric representations of the same or different objects may be obtained and rendered as described above.

In some examples, the user may manipulate (e.g., move, resize, rotate) previously drawn objects on the display 112. For instance, an “edit” command object may be used to perform these operations. In one example, assuming that there is only one prior existing line on the display 112, if the user introduces a straight object and moves it around so the position of the object coincides with the existing line on the display 112, the system may lock the physical object to the line in the display 112. From this time on, whenever the user moves the object the line on the display 112 moves with it, and to fix a new position of the object, the object may be held stationary for a predetermined period of time or a command object may be introduced as disclosed elsewhere in this specification.

To change the size of existing objects, the user may utilize an “edit size” command object and then move a tiny ball object in the real physical world until it coincides with the end-point of an existing line or a corner of an existing plane on the display 112. Then, that point is locked to the ball. From that time, whenever the user moves the ball only the selected point on the display 112 moves with the ball thus resizing the prior existing object. It will be appreciated that the “edit” and “edit size commands” are only two examples of commands and other examples of commands are possible.

Consequently, the present approaches allow a user to create a three-dimensional image of a complex object from basic geometric shapes (e.g., lines, squares). For instance a user could use a pencil and sheet of paper to create a complex model in three-dimensional space by repeatedly moving the pencil and sheet of paper in the field of view of the image capture device 106. When the object (e.g., the pencil or sheet of paper) is in the position desired, a visual indicator is introduced to fix the location of or render the object. Techniques can also be provided to erase, move, or change portions of the rendered image. The user can view the object being created and the positions of the pencil and paper as the model is being created (e.g., at the display 112). It will be appreciated that these approaches are applicable to a wide variety of applications such as model building, video games, toys, drafting tools, and computer animation, to name a few.

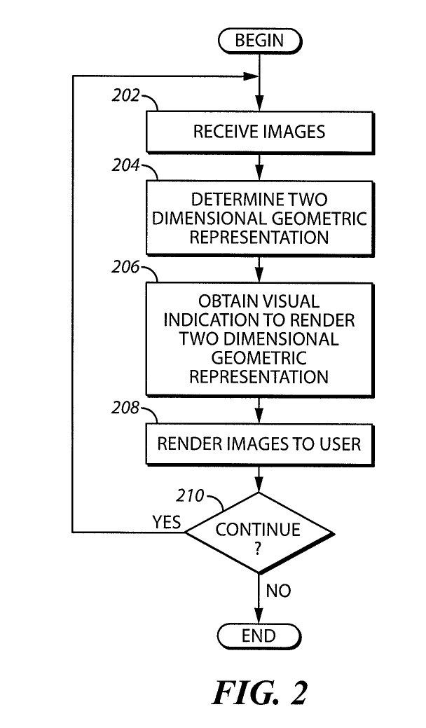

Referring now to FIG. 2, one example of an approach of creating and rendering images of objects to users is described. At step 202, images of a moving object are received. For example, the images may be of a moving object such as a pen, pencil, or sheet of paper. The images of the moving object(s) may be used to visually create and visually render a more complex object to a user. In this example, lines represented by the pen, pencil, and sheet of paper can be connected in three-dimensional space to create a more complex object.

At step 204, a two-dimensional geometric representation of the object in the image is determined. For example, when an elongated object (e.g., a pencil or pen) is used, the system may visually represent the pen as a line. In another example, a square sheet of paper may be represented as a square plane. As discussed elsewhere in this specification, the system may analyze a series of frames in a frame-by-frame basis to determine a moving object, track the object, and render the object to a user.

At step 206, a visual indication is obtained that renders the two-dimensional geometric representation. In other words, an indication (e.g., a hand gesture, expiration of a timer, or introduction of a command object) is received to fix the movement and location of the geometric representation of the moving object. At step 208, the geometric representation is rendered to the user. In other words, the geometric representation (at the location fixed at step 206) is drawn or presented to the user, for instance, on a video display terminal.

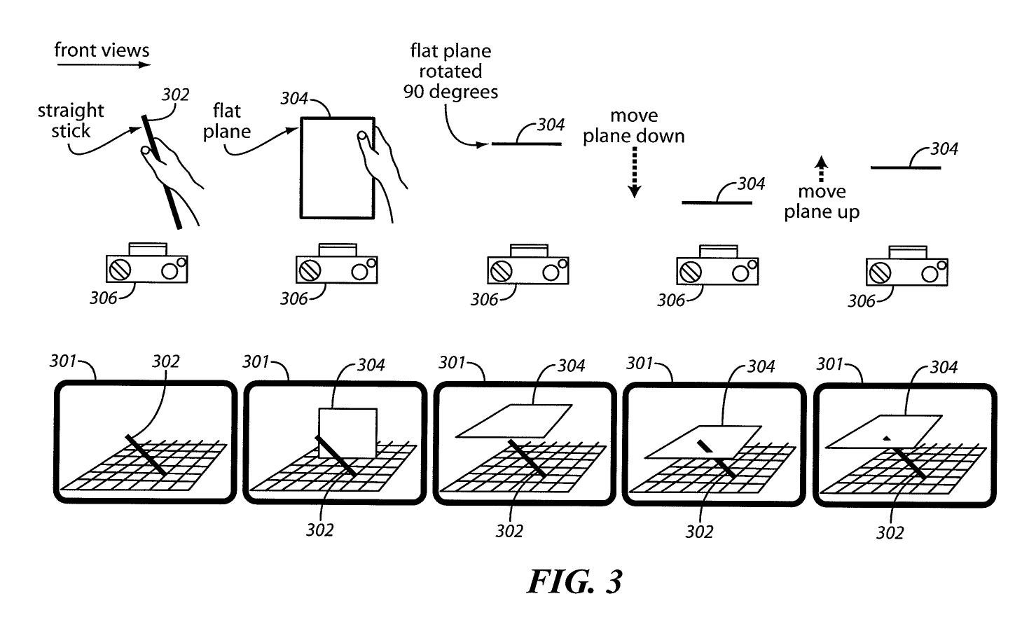

Referring now to FIG. 3, examples of approaches for rendering geometric representations of objects to users are described. A camera 306 obtains images of moving objects. The images of the objects are presented in a three-dimensional space at a display 301. In this example, a linear object 302 is introduced and images obtained by the camera 306 of the linear object 302 as the linear object 302 moves. A geometric representation of the moving object 302 is determined, in this case, a line. As shown, the object 302 is represented as a line one the display 301. A planar object 304 is then introduced. As shown, the plane can be rotated and moved up and down. The movement of the planar object 304 is displayed on the display 301.

A visual indictor may be obtained to fix the location of the linear object 302. For instance, if a command object (i.e., a predetermined object programmed to be recognized by the system) is detected, the geometric representation is fixed and rendered to the user. In this case, a thumbs up sign is introduced and the position of the line representing the pencil is fixed at a location when the command object is detected.

Various approaches may be used to determine the endpoints and corners of moving objects so that the moving objects can be tracked. For example, the straight lengths of highlighted pixel arrays (the highlights representing moving objects) are obtained. In this case, the arrays with the shorter dimension (e.g., two) identify the end points. The identified endpoints can then be tracked by the system.

Finding the corners of a flat plane object may utilize vectors along the edges of the highlighted pixel arrays (the highlighted area representing moving objects and the flat plane). The points of intersection of the direction vectors denote the corners and from that point onward, the corners can be continuously tracked by the system.

Tracking the endpoints of the straight edge and the corners of the flat plane can be accomplished using a variety of approaches. For example, the pixels may be saved to form a small section of the area around the end points and corners as signatures. Pattern matching techniques may be used to track these pivots in two-dimensional space in all frames. Any change in size of the endpoint signatures may indicate a rotation of the straight edge containing that point. An increase in size denotes a rotation that brings the point closer to the camera and a decrease in size denotes a rotation that takes the endpoint away from the camera. An increase in the angle of intersection of the direction vectors of the flat plane indicates a rotation of the plane, meaning a normal vector to the flat plane is no longer parallel to the sight vector. The direction of rotation is determined by increasing/decreasing size of the pixel edge arrays.

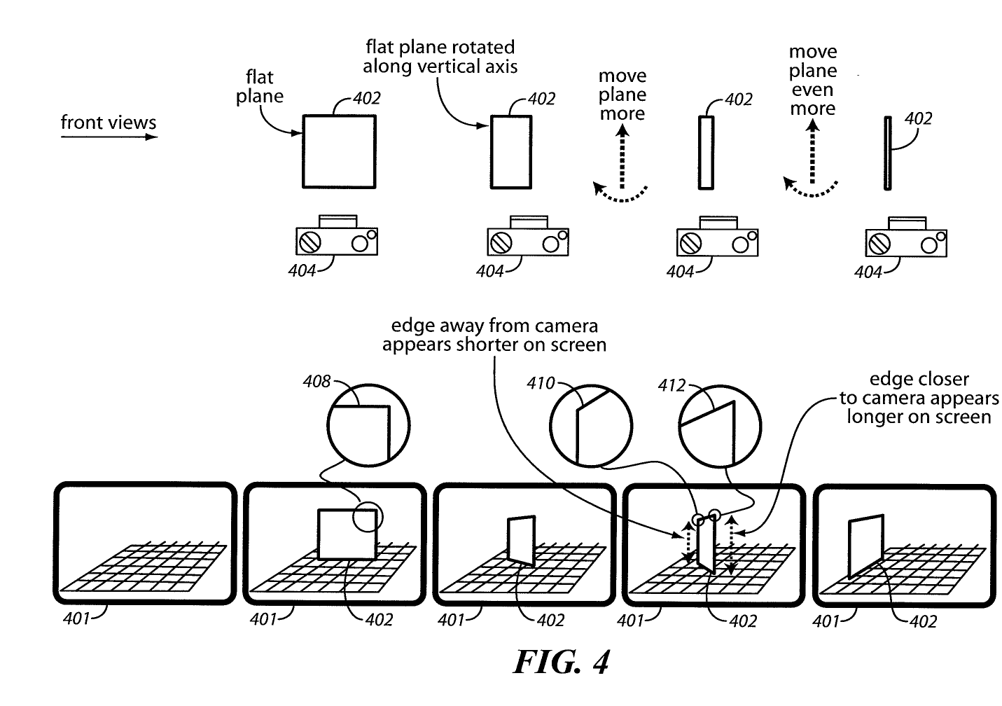

Referring now to FIG. 4, examples of approaches of rendering geometric representations of objects to users is described. A camera 404 obtains images of objects. The images of the objects are displayed in a three-dimensional space at the display 401. As shown, a planar object 402 may be introduced, moved, and rotated. The movement and rotation is displayed on the display 401. As displayed, the object includes corners. The upper left part of the object appears as corner 408 when the object is facing the image capture device 404. As the object is rotated, the corners appear as corner 410 and 412. The edge with the corner 410 appears further away than the edge with corner 412.

As with FIG. 3, a visual indictor may be obtained to fix the location of the object. For instance, if a command object (a predetermined object programmed into the system) is detected, the geometric representation is fixed and rendered to the user. In one example, a thumbs up sign is introduced and the position of the shape representing the pencil fixed where it is when the command object is detected. The object 402 can be tracked as described above with respect to FIG. 3.

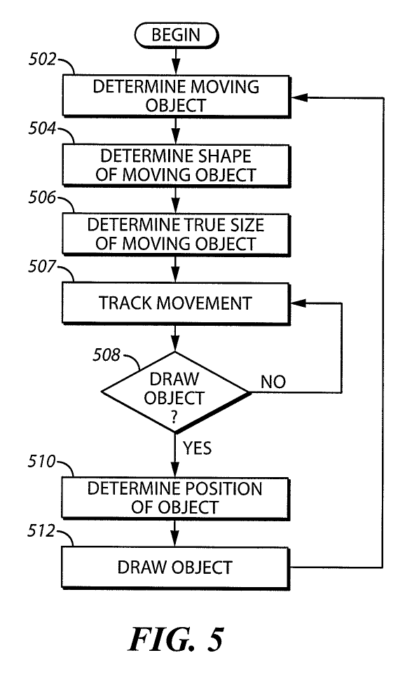

Referring now to FIG. 5, one example of determining the geometric representation of an object is described. At step 502, the moving object is determined. With this step, moving objects are distinguished from stationary objects. In one example, moving objects may be represented as binary ones in a pixel array while stationary objects are represented by a binary zero. This step may be achieved by pixel subtraction between two subsequent frames.

At step 504, the shape of the moving object is determined. For example, the system may determine whether the shape is a line or square plane. At step 506, the best estimate of the true size of the moving object is determined. This best estimate is used to track the object. At step 507, movement of the object is tracked. At step 508, it is determined whether to draw or render the object. If the answer is affirmative, execution continues at step 510. If the answer is negative, execution continues with step 507 as described above.

At step 510, the position of the object is determined or fixed. Determining the final position of the object can be accomplished by any suitable technique. The system may determine the duration in terms of number of frames or time of the straight edge/plane remaining stationary based upon a threshold of limited movement (e.g., it is unlikely that a person can hold an object absolutely stationary) and recording that position and orientation as the one to be drawn.

At step 512 the object is drawn or rendered to the user at the location fixed at step 510. Execution continues with step 502 as described above.

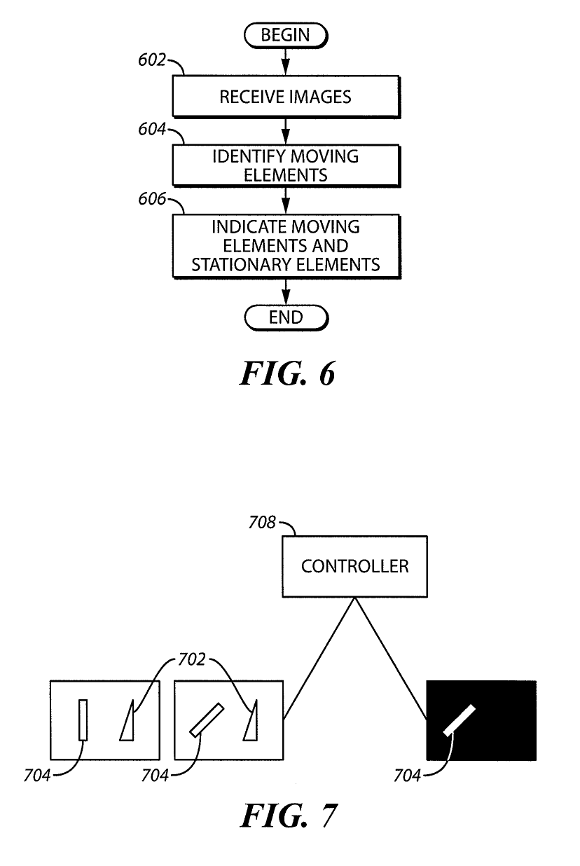

Referring now to FIG. 6, one example of an approach for determining a moving object is described. At step 602, images are received from an image capture device, for example, from a camera. At step 604, moving elements in the images are determined. For example, neighboring frames of a video clip may be compared to identify which pixels move from frame to frame. At step 606, the moving elements are identified and the stationary elements are identified using techniques such as pixel subtraction. In one example, the moving elements are highlighted and the stationary elements are removed to form a video clip where only the moving elements are shown.

Referring now to FIG. 7, a controller 708 is used to identify moving objects 704 in video images as compared to stationary objects 702 in the same images. As shown, the controller 708 identifies the moving and stationary objects and removes the stationary objects to form a new image where only stationary objects 706 are shown.

The new image may be created and only moving objects are identified. A pixel may have a value of one for the object and a zero value otherwise. In other words, the object may be a highlighted area of pixels whose values are one while the remaining parts of the image have pixel values of zero. Pixel subtraction techniques could be used to subtract pixels between adjacent frames to render inanimate objects dark and highlight animate objects.

It will be appreciated that the approaches illustrated in FIGS. 6 and 7 are only one example of approaches for identifying moving and non-moving objects. Other approaches may also be used.

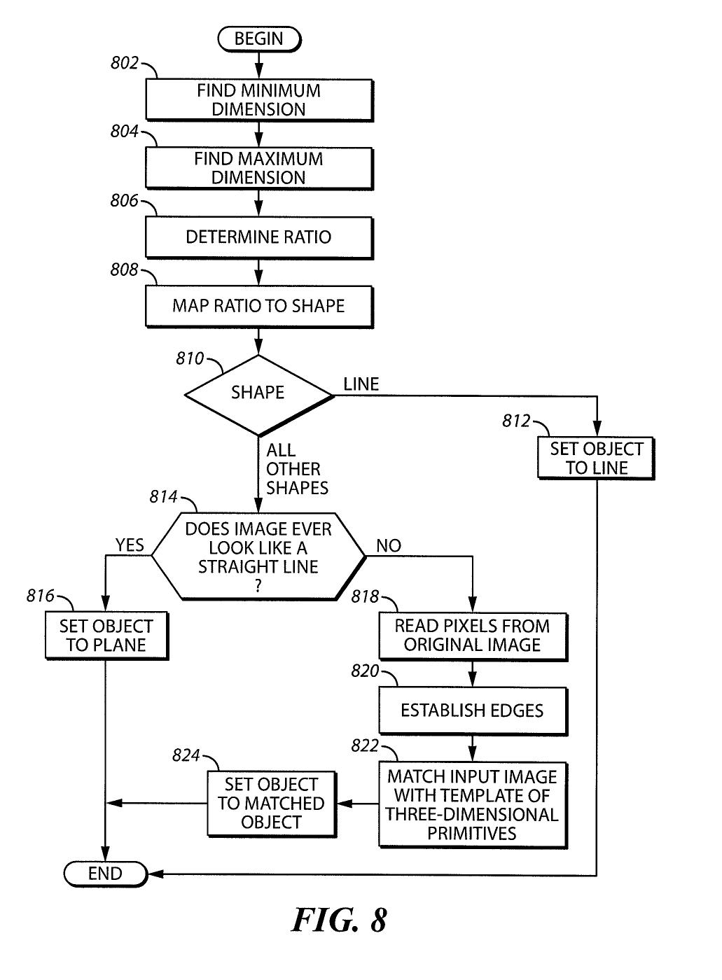

Referring now to FIG. 8, one example of an approach for determining the shape of an object is described. At step 802, a minimum dimension of the object is determined. For example, the minimum edge value is determined. At step 804, a maximum dimension is determined. For example, the maximum edge value is determined. At step 806, a ratio of the minimum value to the maximum value is calculated. At step 808, the determined ratio is matched to a shape. In this case, the ratio may correspond to a first range of values for lines and another range of values for other types of shapes.

At step 810 the shape that has been determined is used to branch to other steps. If the shape is determined to be a line, then at step 812 the object is set to be a line for future processing. Execution then ends.

If the shape is not a line (i.e., all other shapes), step 814 evaluates whether the image appears sufficiently similar (within a predetermined tolerance) to a line in any of the first few frames of images when the subject was introduced. If the answer at step 814 is affirmative, at step 816 the object is set to a plane. Execution then ends.

If the answer at step 814 is negative, at step 818, pixels are read from the original image. At step 820, these pixels are evaluated to determine edges. At step 822, the evaluated edges are mapped to a set of predetermined object patterns and the shape is determined based upon the closest match. At step 824, the object is set to be the matched object.

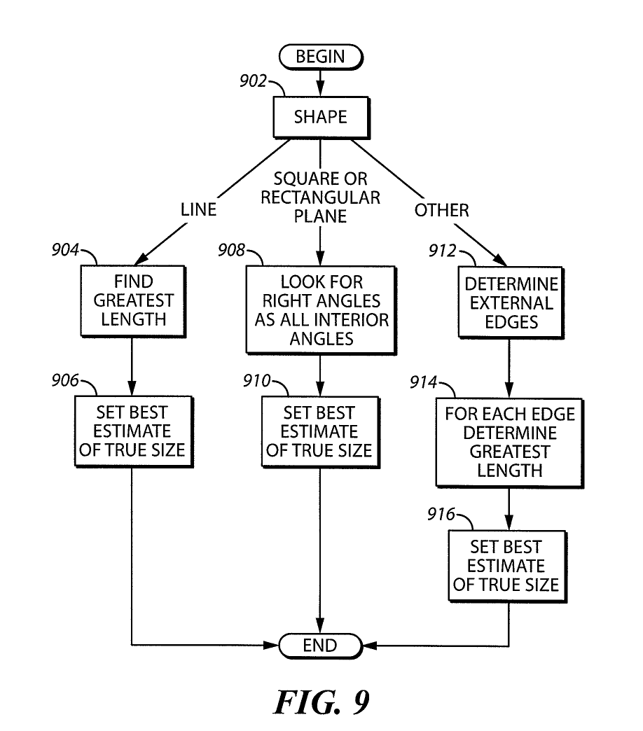

Referring now to FIG. 9, one example of finding a best estimate for the true size of an object is described. At step 902, the determined shape is considered. If the shape is a line, at step 904, the greatest length of the line is determined from the sequence of the first few frames when the subject was introduced. This greatest length so determined is then set to be the best estimate of line size at step 906. The user may need to rotate the subject around so that the image capture device can record views of the subject from various angles. In one approach, the subject should be oriented at least once at such an angle so that the image capture device may capture a best estimate of the true size of the subject.

If the shape is a square or rectangular plane, at step 908 the system examines the received images until it identifies all interior angles of the object as being right angles. When the angles are so identified, at step 910, the system sets the size of the edges of the object as the best estimate of size.

If the object is some other shape, at step 912, the external edges are determined. For each of the edges, the greatest length is determined at step 914. At step 916, the best estimate of size is set to be equal to these edges having this greatest length.

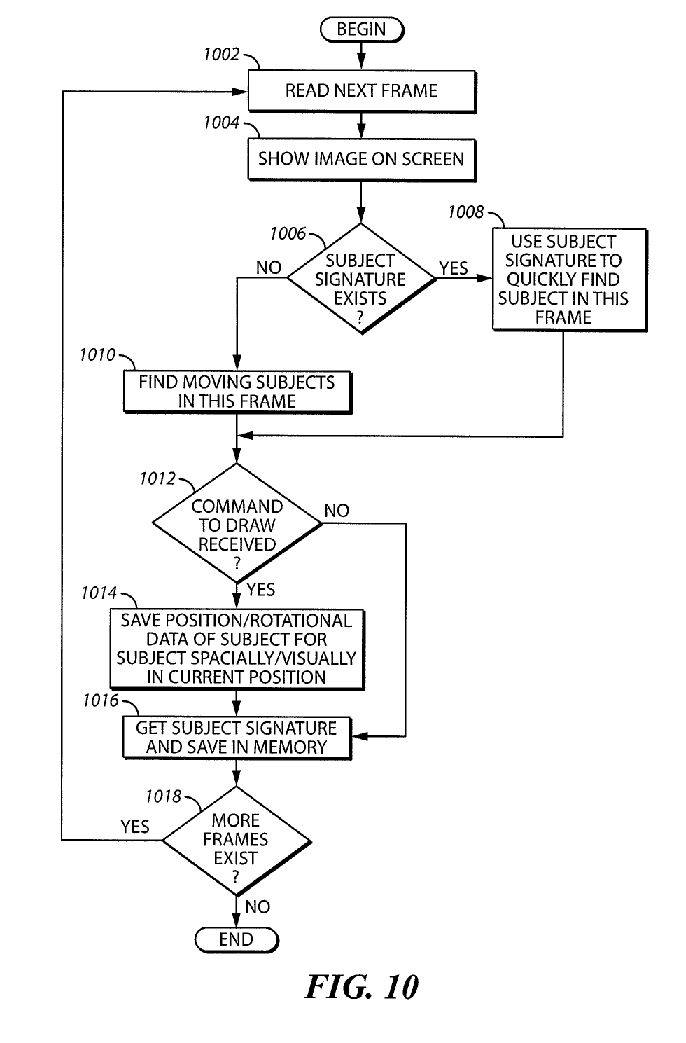

Referring now to FIG. 10, one example of rendering objects to a user is described. At step 1002, the system reads the next frame in a series of images. At step 1004, the image is displayed. At step 1006, it is determined if a signature of the subject exists. If the answer is affirmative, at step 1008, the signature of the subject is used to find the subject in the frame. Execution continues at step 1012 as described below.

If the answer at step 1006 is negative, then at step 1010, the moving object is located in the frame. At step 1012, it is determined if a command to draw has been received. If the answer is negative, execution continues at step 1016 as described below.

If the answer at step 1012 is affirmative, at step 1014 position/rotational data is saved for the subject spatially/visually at the position. At step 1016, the subject signature is obtained and saved in memory. At step 1018, it is determined if more frames exist. If the answer is negative, execution ends. If the answer is affirmative, execution continues with step 1002 as described above.

Thus, approaches are provided that allow the creation and rendering of objects in three-dimensional space to users. These approaches do not require the use of computer attachments (e.g., a keyboard, a computer mouse, or the like) or wires, are intuitive and easy to use, are cost effective to implement, and result in increased user satisfaction with the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of forming visual representations of objects for presentation to a user comprising:
determining a first two-dimensional geometric representation of a first moving object from a received first image;
obtaining a first visual indication to render the first two-dimensional geometric representation of the first moving object in a three-dimensional space; and
responsively visually rendering the first moving object in the three-dimensional space to a user according to the first two-dimensional geometric representation.

2. The method of claim 1 wherein the first two-dimensional geometric representation is selected from a group comprising a line and a polygon.

3. The method of claim 1 further comprising determining a second two-dimensional geometric representation of a second moving object from at least one received second image, obtaining a second indication to render the second two-dimensional geometric representation of the second moving object in the three-dimensional space, and responsively visually rendering the second moving object in the three-dimensional space to the user according to the second two-dimensional geometric representation.

4. The method of claim 1 wherein the first visual indication is at least one indication selected from a group comprising a hand gesture; the introduction of a command object; and expiration of a time period during which the first object remains stationary.

5. The method of claim 1 wherein the received at least one first image comprises at least one set of images selected from a group comprising: a set of images captured and a set of stored images.

6. The method of claim 1 wherein determining a first two-dimensional geometric representation comprises locating a position of the first moving object in the three-dimensional space.

7. The method of claim 6 wherein locating the position of the first moving object in the three-dimensional space comprises determining a set of edge vectors and evaluating the set of edge vectors to determine a shape of the first two-dimensional geometric representation.

8. The method of claim 1 wherein the received first images are obtained from an image capture device selected from a single image capture device and a plurality of image capture devices.

9. A system for creating visual representations of objects for presentation to a user comprising:
an interface having an input and an output; and
a controller, the controller coupled to the interface, the controller being configured and arranged to determine a first two-dimensional geometric representation of a first object as the first object moves based upon image data received at the input of the interface, the controller being further arranged and configured to obtain a first visual indication at the input of the interface to render the first two-dimensional visual geometric representation of the first object in a three-dimensional space, the controller being further configured and arranged to responsively present the first two-dimensional geometric representation of the object at the output of the interface for display to a user.

10. The system of claim 9 wherein the first two-dimensional geometric representation is selected from a group comprising a line and a polygon.

11. The system of claim 9 wherein the controller is further arranged and configured to determine a second two-dimensional geometric representation of a second object as the second object moves, obtain a second indication to represent the second two-dimensional geometric representation of the second object in the three-dimensional space, the second indication being received at the input of the interface, and responsively present the second two-dimensional geometric representation at the output of the interface for display to the user.

12. The system of claim 9 wherein the first visual indication is at least one indication selected from a group comprising a hand gesture; the introduction of a second object; and expiration of a time period during which the first object remains stationary.

13. The system of claim 9 wherein the controller is configured and arranged to determine a set of edge vectors from the image data and evaluate the edge vectors to determine the first two-dimensional geometric representation.

14. The system of claim 9 further comprising an image capture device selected from a group comprising a single image capture device coupled to the input of the interface and a plurality of image capture devices coupled to the input of the interface.

15. The system of claim 9 further comprising an image presentation device coupled to the output of the interface.

16. The system of claim 15 wherein the image presentation device is selected from a group comprising a Cathode Ray Tube (CRT) display and a liquid crystal display (LCD).

17. The system of claim 9 wherein the controller is further configured and arranged to receive a third indicator at the input of the interface, the third indicator requesting the creation of a third two-dimensional geometric representation, the third two-dimensional geometric representation being a combination of the first and second two-dimensional geometric representations.
